(19) United States
(12) Patent Application Publication
(10) Pub. No.: US 2014/0128516 A1
(43) Pub. Date: May 8, 2014

(54) Flame Retardant-Stabiliser Combination For Thermoplastic Polymers

(71) Applicants: Sebastian Hoerold, Diedorf (DE); Harald Bauer, Kerpen (DE)

(72) Inventors: Sebastian Hoerold, Diedorf (DE); Harald Bauer, Kerpen (DE)

(73) Assignee: CLARIANT FINANCE (BVI) LIMITED, Tortola (VG)

(21) Appl. No.: 14/000,774

(22) PCT Filed: Feb. 14, 2012
(86) PCT No.: PCT/EP2012/000652

§ 371 Date: Nov. 1, 2013

(30) Foreign Application Priority Data
Feb. 22, 2011 (DE) 10 2011 011 928.0

(51) Int. Cl. C08K 13/02; C09K 21/12

(52) U.S. Cl. CPC C08K 13/02; C09K 21/12
USPC 524/89; 524/100; 252/602

(57) ABSTRACT

A flame retardant-stabiliser combination for thermoplastic polymers, containing as component A: 50 to 90% by weight of a monoaryl phosphinic acid salt of the general formula (I), where R¹ is an unsubstituted or substituted C₆-C₁₅ aryl group or a C₇-C₁₆ alkyl aryl group or a C₇-C₁₆ aryl alkyl group; M is Mg, Ca, Al, Sb, Sn, Ge, Ti, Zn, Fe, Zr, Ce, Bi, Sr, Mn, Li, Na, K and/or a protonized nitrogen base; as component B: 5 to 50 wt % of a nitrogen-containing synergist and/or a phosphorus/nitrogen flame retardant; as component C: 0 to 10 wt % of magnesium oxide, calcium oxide, zinc oxide, manganese oxide, tin oxide, aluminium hydroxide, boehmite, magnesium hydroxide, hydrotalcite, hydrocalumite, calcium hydroxide, zinc hydroxide, tin oxide hydrate, manganese hydroxide, zinc borate, zinc hydroxystannate and/or zinc stannate; as component D: 0 to 3 wt % of a mixture of a phosphonite or a phosphonite/phosphate mixture, and as component E: 0 to 3 wt % of an ester or salt of long-chain aliphatic carbonic acids having 14 to 40 C atoms, wherein the sum of the components A to E totals 100 wt %.

The invention relates to a flame retardant-stabilizer combination for thermoplastic polymers, and also to polymeric molding compositions and moldings which comprise flame retardant-stabilizer combinations of this type.

With a few exceptions, thermoplastics, also termed polymers, are processed in the melt. The attendant structural changes and phase changes cause alterations in the chemical structure of almost all plastics. Among the results can be crosslinking, oxidation, molecular weight changes, and also consequential changes in physical and technical properties. In order to reduce the stress to which the polymers are subjected during processing, various additives are used, depending on the plastic. A general procedure is to add stabilizers which suppress or at least retard undesired alterations such as crosslinking reactions or degradation reactions. Other materials also added to most plastics are lubricants, which mainly serve to improve the flow behavior of the melt.

A large number of different additives are generally used simultaneously, and each of these assumes its own function: antioxidants and stabilizers are used to prevent adverse chemical effects on the plastic during processing, and then to render the plastic resistant over long periods to exterior effects such as heat, UV light, weathering, and oxygen (air). Lubricants not only improve flow behavior but also prevent excessive adhesion of the plastics melt to hot machinery components, and act as dispersing agents for pigments, fillers, and reinforcing materials.

The stability of plastics during processing in the melt can be influenced by the use of flame retardants. It is frequently necessary to add large amounts of flame retardants in order to ensure that the plastic has adequate flame retardancy in accordance with international standards. Flame retardants have the chemical reactivity required to exert the flame-retardant effect at high temperatures, and they can therefore impair the processing stability of plastics. Examples of possible effects are increased polymer degradation, crosslinking reactions, evolution of gases, and discoloration: effects which may not occur, or occur only to a smaller extent, during processing of plastics without flame retardants.

When no flame retardants are added, polyamides by way of example are stabilized by small amounts of copper halides, and also aromatic amines and sterically hindered phenols, emphasis being placed here on achievement of stability over a long period at high long-term service temperatures (H. Zweifel (ed.): “Plastics Additives Handbook”, 5^{th} Edition, Carl Hanser Verlag, Munich, 2000, pages 80 to 84).

The salts of phosphinic acids (phosphinates) have proven to be effective flame-retardant additions in particular for thermoplastic polymers, such as polyamides and polyesters (DE-A-2 252 258 and DE-A-2 447 727). Calcium phosphinates and aluminum phosphinates have been described as particularly effective in polyesters, and impair the properties of the polymer molding composition materials less than, for example, the alkali metal salts (EP-A-0 699 708).

Synergistic combinations of phosphinates with certain nitrogen-containing compounds have moreover been found, and are more effective than the phosphinates alone as flame retardants in many polymers (PCT/EP97/01664, and also DE-A-197 34 437 and DE-A-197 37 727).

Carbodiimides, isocyanates, and isocyanurates have proven to be effective in stabilizing polymer molding compositions with phosphorus-containing flame retardants (DE-A-199 20 276).

When phosphorus-containing flame retardants are used in polyamides, in particular, the stabilizers described hitherto have proven to have inadequate effect, specifically in suppressing the effects such as discoloration and molecular weight degradation that occur during processing.

DE-A-196 14 424 describes phosphinates in combination with nitrogen synergists in polyesters and polyamides. DE-A-199 33 901 describes phosphinates in combination with melamine polyphosphate as flame retardant for polyesters and polyamides. However, when these very effective flame retardants are used, partial polymer degradation can occur, as also can discoloration of the polymer, in particular at processing temperatures above 300° C.

EP-A-0 794 189 describes phosphonous salts as flame retardants. Phosphonous acid derives from the general formula RHP(O)(OH), and preferred salts are aluminum salts and calcium salts, and R is an alkyl moiety having from 1 to 12 carbon atoms or an aryl moiety, or an alkylaryl moiety. However, the amount added in a polyester is relatively high: from 20 to 30%.

US-A-2008/0132619 describes phosphinic salts which are volatile from 300° C. as effective flame-retardant additives in comparison with less volatile phosphonic salts.

PCT/US2006/045770 describes flame-retardant thermoplastic polymers which comprise a mixture of metal salts of dialkylphosphinic acids and monoalkylphosphinic acids. The content of monoalkylphosphinic salt is from 0.5 to 50%. Only the salts of isobutylphosphinic acid are described.

However, a disadvantage with use of phosphonic salts with relatively high volatility is the formation of mold deposits during injection molding, of exudate during storage under warm, humid conditions, and of emissions during compounding.

Surprisingly, it has been found that certain monoarylphosphinic salts, with selected synergists and optionally with a further stabilizer, are effective flame retardant systems for polymers and at the same time do not exhibit any polymer degradation, and do not exhibit any deposits or exudate.

The invention therefore provides a mixture of a salt of a monoarylphosphinic acid (component A) with nitrogen-containing synergists or with a phosphorus-nitrogen flame retardant (component B), and optionally with a further component (component C), and also optionally with other components.

The invention therefore provides a flame retardant-stabilizer combination for thermoplastic polymers, comprising as component A from 50 to 95% by weight of a monoarylphosphinic salt of the general formula (I)

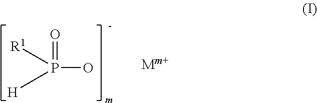

in which
R¹ is a unsubstituted or substituted C₆-C₁₅-aryl group or a C₇-C₁₆-alkylaryl group or a C₇-C₁₆-arylalkyl group;
M is Mg, Ca, Al, Sb, Sn, Ge, Ti, Zn, Fe, Zr, Ce, Bi, Sr, Mn, Li, Na, K, and/or a protonated nitrogen base;
   as component B from 5 to 50% by weight of a nitrogen-containing synergist and/or of a phosphorus/nitrogen flame retardant; as component C from 0 to 10% by weight of magnesium oxide, calcium oxide, zinc oxide, manganese oxide, tin oxide, aluminum hydroxide, boehmite, magnesium hydroxide, hydrotalcite, hydrocalumite, calcium hydroxide, zinc hydroxide, tin oxide hydrate, manganese hydroxide, zinc borate, zinc hydroxystannate, and/or zinc stannate; as component D from 0 to 3% by weight of a mixture of a phosphonite or of a phosphonite/phosphite mixture, and as component E from 0 to 3% by weight of an ester or salt of long-chain aliphatic carboxylic acids having from 14 to 40 carbon atoms, where the entirety of components A to E is always 100% by weight.

Surprisingly, it has been found that inventive combinations of salts of this monophosphinic acid with nitrogen-containing synergists or with a phosphorus-nitrogen flame retardant, together with component C, exhibit markedly better flame-retardant effect and markedly improved stability on incorporation into polymers in comparison with the use of salts of monoalkyl- or monoarylphosphinic acids as sole flame retardants, as described in EP-A-0794 189.

Addition of nitrogen-containing synergists or of a phosphorus/nitrogen flame retardant, and of a particular metal compound (component C), can considerably improve flame-retardant effect, and can prevent polymer degradation. Mold deposits and exudate are moreover observed to be absent.

The inventive combinations reduce discoloration of the plastics during processing in the melt and suppress degradation of the plastics to give units with lower molecular weight.

R¹ is preferably phenyl or naphthyl, or monomethyl-, dimethyl-, or trimethyl-substituted phenyl, such as 2,4,6-trimethylphenyl.

The flame retardant-stabilizer combination preferably comprises from 50 to 80% by weight of component A, from 20 to 50% by weight of component B, from 0.1 to 10% by weight of component C, from 0 to 3% by weight of component D, and from 0 to 2% by weight of component E

The flame retardant-stabilizer combination particularly preferably comprises from 50 to 75% by weight of component A, from 25 to 50% by weight of component B, and from 2 to 10% by weight of component C, from 0.1 to 2% by weight of component D, and from 0 to 1% by weight of component E.

Component B preferably relates to condensates of melamine. Condensates of melamine are by way of example melem, melam, and melon, and compounds of this type having higher condensation levels, and also mixtures of the same, and can by way of example be produced via a process as described in WO-A-96/16948.

The phosphorus/nitrogen flame retardants preferably relate to reaction products of melamine with phosphoric acid or with condensed phosphoric acids, or relate to reaction products of condensates of melamine with phosphoric acid or with condensed phosphoric acids, or else relate to mixtures of the products mentioned.

The reaction products with phosphoric acid or with condensed phosphoric acids are compounds produced via reaction of melamine or of the condensed melamine compounds, such as melam, melem, or melon etc., with phosphoric acid. Examples here are dimelamine phosphate, dimelamine pyrophosphate, melamine phosphate, melamine pyrophosphate, melamine polyphosphate, melam polyphosphate, melon polyphosphate, and melem polyphosphate, and mixed polysalts as described by way of example in WO-A-98/39306.

The phosphorus/nitrogen flame retardants preferably relate to nitrogen-containing phosphates of the formulae (NH₄)_{y}H_{3-y} PO₄ or (NH₄PO₃)_{z}, where y is from 1 to 3 and z is from 1 to 10 000.

The nitrogen-containing synergists preferably relate to those of the formulae (II) to (VII), or mixtures thereof

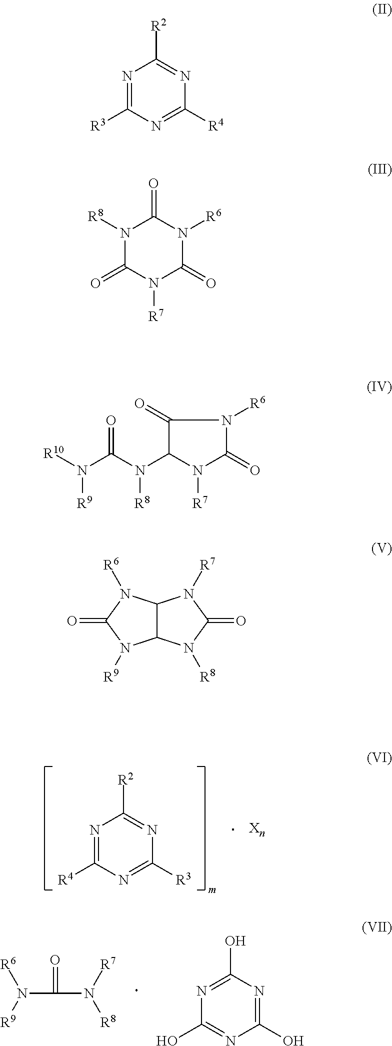

in which
R² to R⁴ are hydrogen, C₁-C₈-alkyl or C₅-C₁₆-cycloalkyl or -alkylcycloalkyl, possibly substituted with a hydroxy or C₁-C₄-hydroxyalkyl function, C₂-C₅-alkenyl, C₁-C₈-alkoxy, -acyl, or -acyloxy, C₆-C₁₂-aryl or -arylalkyl, —OR⁵ or —N(R⁵)R⁶, including systems of alicyclic-N or aromatic-N type,
R⁵ is hydrogen, C₁-C₈-alkyl or C₅-C₁₆-cycloalkyl or -alkylcycloalkyl, possibly substituted with a hydroxy or C₁-C₄-hydroxyalkyl function, C₂-C₈-alkenyl, C₁-C₈-alkoxy, -acyl, or -acyloxy, or C₆-C₁₂-aryl or -arylalkyl,
R⁶ to R¹⁰ are the same groups as R⁵ or else are —O—R⁵,
m and n are mutually independently 1, 2, 3, or 4,
X represents acids which can form adducts with triazine compounds (II);
   or relate to oligomeric esters of tris(hydroxyethyl) isocyanurate with aromatic polycarboxylic acids.

The nitrogen-containing synergists preferably relate to benzoguanamine, tris(hydroxyethyl) isocyanurate, allantoin, glycoluril, melamine, melamine cyanurate, dicyandiamide, guanidine, carbodiimides.

The phosphites and phosphonites (component D) preferably relate to triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, bisisodecyloxy pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocin, 6-fluoro-2,4,8,10-tetra-tert-butyl-12-methyldibenzo[d,g]-1,3,2-dioxaphosphocin, bis(2,4-di-tert-butyl-6-methylphenyl) methyl phosphite and/or bis(2,4-di-tert-butyl-6-methylphenyl) ethyl phosphite.

Suitable as component E are esters or salts of long-chain aliphatic carboxylic acids (fatty acids), typically having chain lengths of from C₁₄ to C₄₀. The esters relate to reaction products of the carboxylic acids mentioned with familiar polyhydric alcohols, e.g. ethylene glycol, glycerol, trimethylolpropane, or pentaerythritol. Particularly useful salts of the carboxylic acids mentioned include the alkali metal or alkaline earth metal salts, or aluminum salts and zinc salts.

The invention also provides a flame-retardant plastics molding composition comprising a total amount of from 2 to 50% by weight, based on the plastics molding composition, or the inventive flame retardant-stabilizer combination.

The plastic preferably relates to thermoplastic polymers of the type represented by HI (high-impact) polystyrene, polyphenylene ethers, polyamides, polyesters, polycarbonates, and blends or polymer blends of the type represented by ABS (acrylonitrile-butadiene-styrene) or PC/ABS (polycarbonate/acrylonitrile-butadiene-styrene), or PPE/HIPS (polyphenylene ether/HI polystyrene) plastics.

The flame-retardant plastics molding composition preferably comprises
from 50 to 98% by weight of plastics molding compositions,
from 2 to 50% by weight of the inventive flame retardant-stabilizer combination, and
from 0 to 50% by weight of additives.

Finally, the invention also provides polymer moldings, polymer films, polymer filaments, and polymer fibers respectively comprising the inventive flame retardant-stabilizer combination.

A feature of the polymer moldings, polymer films, polymer filaments, and polymer fibers is that they relate to HI (high-impact) polystyrene, polyphenylene ethers, polyamides, polyesters, polycarbonates, or blends or polymer blends of the type represented by ABS (acrylonitrile-butadiene-styrene) or PC/ABS (polycarbonate/acrylonitrile-butadiene-styrene), polyamide, polyester, and/or ABS.

The polymer moldings, polymer films, polymer filaments, and polymer fibers preferably comprise a total amount of from 2 to 50% by weight, based on the polymer content, of the flame retardant-stabilizer combination.

The polymer moldings, polymer films, polymer filaments, and polymer fibers preferably comprise
from 50 to 98% by weight of plastics molding compositions,
from 2 to 50% by weight of the flame retardant-stabilizer combination as claimed in one or more of claims 1 to 12, or a flame-retardant plastics molding composition as claimed in claim 13 or 14,
from 0 to 50% by weight of additives.

Other additives can be added to the inventive combination of a salt of a monoarylphosphinic acid and with nitrogen-containing synergists or with phosphorus-nitrogen flame retardants, examples being antioxidants, UV absorbers, light stabilizers, fillers and reinforcing agents, lubricants and mold-release agents, metal deactivators, and nucleating agents. These additional additives can be added to the polymers before, together with, or after addition of the flame retardants. The form in which these additives, and also the flame retardants, are added here can be that of solid, solution, or melt, or else that of a solid or liquid mixture, or masterbatch/concentrate.

Component C preferably relates to zinc borate or zinc stannate.

Component C particularly preferably relates to dihydrotalcite or boehmite.

M is preferably calcium, aluminum, or zinc.

Protonated nitrogen bases are preferably the protonated bases of ammonia, melamine, or triethanolamine, in particular NH₄⁺.

The phosphorus/nitrogen flame retardant particularly preferably relates to melamine polyphosphate.

The phosphorus/nitrogen flame retardant preferably relates to ammonium hydrogenphosphate, ammonium dihydrogenphosphate, or ammonium polyphosphate.

The inventive flame retardant-stabilizer combination can also comprise carbodiimides.

Component E preferably relates to esters or salts of stearic acid, e.g. glycerol monostearate or calcium stearate.

Component E preferably relates to reaction products of montan wax acids with ethylene glycol.

The reaction products preferably relate to a mixture of ethylene glycol mono-montan wax acid ester, ethylene glycol di-montan wax acid ester, montan wax acids, and ethylene glycol.

Component E preferably relates to reaction products of montan wax acids with a calcium salt.

The reaction products preferably relate to a mixture of 1,3-butanediol mono-montan wax acid ester, 1,3-butanediol di-montan wax acid ester, montan wax acids, 1,3-butanediol, calcium montanate, and of the calcium salt.

The quantitative proportions of components A, B, and C in the flame retardant-stabilizer combination depend in essence on the intended application sector, and can vary widely. As a function of application sector, the flame retardant-stabilizer combination comprises from 50 to 95% by weight of component A, from 5 to 50% by weight of component B, and from 0.1 to 10% by weight of component C. The amounts added of components D and E are mutually independently from 0 to 3%.

The plastic particularly preferably relates to polyamides, polyesters, and PPE/HIPS blends.

The total amount used of the flame retardant-stabilizer combination in the plastics molding composition is particularly preferably from 10 to 30% by weight, based on the plastics molding composition.

The polymer moldings, polymer films, polymer filaments, and polymer fibers particularly preferably comprise a total amount of from 10 to 30% by weight, based on the polymer content, of the flame retardant-stabilizer combination.

In one particular embodiment, the polymer moldings, polymer films, polymer filaments, and polymer fibers comprise from 2 to 30% by weight of the flame retardant-stabilizer combination, composed of from 50 to 80% by weight of component A, of from 20 to 50% by weight of component B, of from 0.1 to 10% by weight of component C, of from 0 to 3% by weight of component D, and from 0 to 3% by weight of component E, based on the polymer content.

The abovementioned additives can be introduced into the plastic in a very wide variety of steps of a process: in the case of polyamides or polyesters, it is possible to mix the additives into the polymer melt at the start of, or at the end of, the polymerization/polycondensation process, or in a subsequent compounding process. There are moreover processing methods in which the introduction of the additives is delayed to a later stage. This is the procedure in particular when pigment masterbatches or additive masterbatches are used. There is moreover the possibility that in particular pulverulent additives are applied in a drum to the pelletized polymer, which may retain heat from the drying process.

The flame retardant-stabilizer combination preferably takes the form of pelletized material, flakes, fine-grain material, powder, and/or micronizate.

The flame retardant-stabilizer combination preferably takes the form of physical mixture of the solids, of melt mixture, of compactate, of extrudate, or of a masterbatch.

The mixture is preferably used in a molding composition of a polyamide or of a polyester. Suitable polyamides are described by way of example in DE-A-199 20 276.

The polyamides preferably relate to those of amino acid type and/or of diamine-dicarboxylic acid type.

The polyamides preferably relate to nylon-6, nylon-6,6, nylon-6,10, nylon-4,6, nylon-4,T, nylon-6,T/6,6, nylon-9,T, nylon-10,T, nylon-11, nylon-12 or nylon-MXD,6.

The polyesters preferably relate to polyethylene terephthalate or polybutylene terephthalate.

The polyamides or polyesters are preferably unaltered, colored, filled, unfilled, reinforced, unreinforced, or else otherwise modified materials.

### EXAMPLES

### 1. Components Used

### Commercially Available Polymers (Pelletized Materials):

nylon-6,6 (GRPA 6.6): Ultramid® A27 (BASF AG, D)
polybutylene terephthalate (PBT): Ultradur® B4500 (BASF AG, D)
Vetrotex® 983 EC 10 4.5 mm glass fibers (Saint-Gobain-Vetrotex, D)
Vetrotex® 952 EC 10 4.5 mm glass fibers (Saint-Gobain-Vetrotex, D)

### Flame Retardant (Component A):

Aluminum salt of monophenylphosphinic acid, hereinafter termed PHEPAL, produced in accordance with EP-A-0 794 189, Example 2

### Flame Retardant Synergist (Component B):

Melamine polyphosphate (termed MPP): Melapur® 200 (Ciba SC, CH)
Melamine cyanurate (termed MC): Melapur® MC50 (Ciba SC, CH)

### Melem: Delacal® 420 (Delamin Ltd, UK)

### Component C:

Firebrake® ZB and Firebrake® 500 zinc borate, Borax, USA
Apyral® AOH 60 boehmite, Nabaltec, Schwandorf, D
Flamtard® S zinc stannate, William Blythe, GB

### Phosphonites (Component D):

### Sandostab® P-EPQ, Clariant, D

### Wax Components (Component E):

Licomont® CaV 102, Clariant, D (Ca salt of montan wax acid)
Licowax® E, Clariant, D (ester of montan wax acid)

### 2. Production, Processing, and Testing of Flame-Retardant Plastics Molding Compositions

The flame retardant components were mixed in the ratio stated in the table with the phosphonite, and the lubricants, and stabilizers, and incorporated by way of the side feed of a twin-screw extruder (Leistritz ZSE 27/44D) at temperatures of from 260 to 310° C. into PA 6.6 or at from 250 to 275° C. into PBT. The glass fibers were added by way of a second side feed. The homogenized polymer extrudate was drawn off, cooled in a water bath, and then pelletized.

After adequate drying, the molding compositions were processed in an injection-molding machine (Arburg 320 C Allrounder) at melt temperatures of from 250 to 300° C. to give test specimens, and tested and classified for flame retardancy on the basis of the UL 94 test (Underwriters Laboratories).

The flowability of the molding compositions was determined via melt volume index (MVR) determination (275° C./2.16 kg). A sharp increase of the MVR value indicates polymer degradation.

Unless otherwise stated, all of the experiments in each series were carried out under identical conditions (temperature profiles, screw geometries, injection-molding parameters, etc.) for reasons of comparability.

Formulations comp-1 to comp-2 are comparative examples in nylon-6,6 GF, using PHEPAL without synergists, i.e. alone.

Examples IE-1 to IE-7 list the results using a flame retardant mixture of the invention in nylon-6,6 GF. All amounts are stated as % by weight.

TABLE 1
PA 66 GF 30 experimental results, comp-1 and comp-2 are comparative
examples; IE-1 to IE-7 are inventive flame retardant mixtures.

| | comp-1 | comp-2 | IE-1 | IE-2 | IE-3 | IE-4 |
|---|---|---|---|---|---|---|
| Nylon-6,6 | 49.55 | 39.55 | 49.55 | 49.55 | 49.55 | 49.55 |
| 983 glass fibers | 30 | 30 | 30 | 30 | 30 | 30 |
| A: PHEPAL | 20 | 30 | 15 | 10 | 9 | 12 |
| B: Melem | | | | 10 | 9 | |
| B: MPP | | | 5 | | | 6 |
| C: Boehmite | | | | | | |
| C: Zinc borate | | | | | 2 | 2 |
| E: CaV 102 | 0.25 | 0.25 | 0.25 | 0.25 | 0.25 | 0.25 |
| D: P-EPQ | 0.20 | 0.20 | 0.20 | 0.20 | 0.20 | 0.20 |
| UL 94 0.8 mm | V-2 | V-0 | V-0 | V-1 | V-0 | V-0 |
| MVR 275° C./ | 12 | 5 | 14 | 15 | 13 | 11 |
| 2.16 kg | | | | | | |
| Polymer extrudate | rough | rough | rough | smooth | smooth | smooth |
| Exudate* | signi- | signi- | signi- | none | none | slight |
| | ficant | ficant | ficant | | | |
| Color | gray | white | white | gray | white | white |
| Impact resistance | 55 | 46 | 65 | 60 | 64 | 63 |
| [kJ/m²] | | | | | | |
| Notched impact | 7.5 | 6 | 11 | 10 | 14 | 14 |
| resistance | | | | | | |
| [kJ/m²] | | | | | | |

| | IE-5 | IE-6 | IE-7 |
|---|---|---|---|
| Nylon-6,6 | 49.55 | 49.55 | 49.55 |
| 983 glass fibers | 30 | 30 | 30 |
| A: PHEPAL | 12 | 12 | 9 |
| B: Melem | 6 | 6 | |
| B: MPP | | | 9 |
| C: Boehmite | | 2 | |
| C: Zinc borate | 2 | | 2 |
| E: CaV 102 | 0.25 | 0.25 | 0.25 |
| D: P-EPQ | 0.20 | 0.20 | 0.20 |
| UL 94 0.8 mm | V-0 | V-0 | V-0 |
| MVR 275° C./ | 12 | 15 | 17 |
| 2.16 kg | | | |
| Polymer extrudate | smooth | smooth | smooth |
| Exudate* | none | none | slight |
| Color | white | white | white |
| Impact resistance | 63 | 63 | 60 |
| [kJ/m²] | | | |
| Notched impact | 13 | 12 | 11 |
| resistance | | | |
| [kJ/m²] | | | |

*14 days at 100% humidity and 70° C.

From the examples it is apparent that when the inventive mixture of the components PHEPAL and MPP and, respectively, melem and zinc borate and, respectively, boehmite is compared with the sole use of PHEPAL, it exhibits improved fire behavior (V-0 for 20% addition), good processability (smooth polymer extrudates), no polymer degradation (high values for impact resistance and for notched impact resistance), and no exudate on storage in warm, humid conditions. When PHEPAL is used alone, UL 94 V-0 is not achieved until addition reaches 30% (comp-2).

Although incorporation of the flame retardants PHEPAL and MPP into PA 6.6 gives UL 94 V-0, it also gives exudate and rough polymer extrudates, gray discoloration of the molding compositions, exudate, and high melt indices (IE-1). Addition of zinc borate can prevent the gray discoloration, and exudate is markedly reduced.

TABLE 2
PBT GF 25 experimental results. comp-3 and comp-4
are comparative examples, and IE-8 to IE-11 are
inventive flame retardant-stabilizer mixture.

| | comp-3 | comp-4 | IE-8 | IE-7 | IE-8 | IE-9 |
|---|---|---|---|---|---|---|
| PBT | 54.55 | 44.5 | 54.55 | 54.55 | 54.55 | 54.55 |
| 952 glass fibers | 25 | 25 | 25 | 25 | 25 | 25 |
| A: PHEPAL | 20 | 30 | 15 | 15 | 12 | 12 |
| B: MC | | | | 5 | 3 | 6 |
| B: MPP | | | 5 | | | |
| B: Melem | | | | | 3 | |
| C: Boehmite | | | | | 2 | |
| C: Zinc | | | | | | 2 |
| stannate | | | | | | |
| E: Licowax E | 0.25 | 0.25 | 0.25 | 0.25 | 0.25 | 0.25 |
| D: P-EPQ | 0.20 | 0.20 | 0.20 | 0.20 | 0.20 | 0.20 |
| UL 94 0.8 mm | V-1 | V-0 | V-0 | V-0 | V-0 | V-0 |
| Color | white | yellow | white | white | white | white |
| Solution | 1115 | 910 | 1377 | 1345 | 1376 | 1358 |
| viscosity SV* | | | | | | |
| Tensile strain | 1.8 | 1.3 | 2.4 | 2.4 | 2.4 | 2.4 |
| at break [%] | | | | | | |
| Impact | 36 | 32 | 47 | 45 | 46 | 48 |
| resistance | | | | | | |
| [kJ/m²] | | | | | | |
| Notched impact | 5.3 | 4.2 | 6.4 | 7.8 | 7.3 | 7.5 |
| resistance | | | | | | |
| [kJ/m²] | | | | | | |

*in dichloroacetic acid, pure PBT (uncompounded): 1450

Incorporation of PHEPAL alone (examples comp-3 and comp-4) leads to marked polymer degradation, discernible from the low solution viscosity values. The mechanical values, too, are low in comparison with PBT comprising no flame retardant. The combination of PHEPAL with the nitrogen synergists and with other additives suppresses polymer degradation almost completely, fire class V-0 is achieved, and the mechanical values are improved.

1. A flame retardant-stabilizer combination for thermoplastic polymers, comprising as component A from 50 to 95% by weight of a monoarylphosphinic salt of the general formula (I) 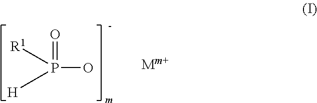
wherein
R¹ is an unsubstituted or substituted C₆-C₁₅-aryl group, a C₇-C₁₆-alkylaryl group or a C₇-C₁₆-arylalkyl group;
M is Mg, Ca, Al, Sb, Sn, Ge, Ti, Zn, Fe, Zr, Ce, Bi, Sr, Mn, Li, Na, K, a protonated nitrogen base or a mixture thereof;
as component B from 5 to 50% by weight of a nitrogen-containing synergist, of a phosphorus/nitrogen flame retardant or a mixture thereof; as component C from 0 to 10% by weight of magnesium oxide, calcium oxide, zinc oxide, manganese oxide, tin oxide, aluminum hydroxide, boehmite, magnesium hydroxide, hydrotalcite, hydrocalumite, calcium hydroxide, zinc hydroxide, tin oxide hydrate, manganese hydroxide, zinc borate, zinc hydroxystannate, zinc stannate or a mixture thereof; as component D from 0 to 3% by weight of a mixture of a phosphonite or of a phosphonite/phosphite mixture, and as component E from 0 to 3% by weight of an ester or salt of long-chain aliphatic carboxylic acids having from 14 to 40 carbon atoms, where the entirety of the components A to E totals 100% by weight.

2. The flame retardant-stabilizer combination as claimed in claim 1, wherein R¹ is phenyl, Of naphthyl or monomethyl-, dimethyl-, or trimethyl-substituted phenyl.

3. The flame retardant-stabilizer combination as claimed in claim 1, comprising from 50 to 79.9% by weight of component A, from 20 to 50% by weight of component B, from 0.1 to 10% by weight of component C, from 0 to 3% by weight of component D, and from 0 to 3% by weight of component E.

4. The flame retardant-stabilizer combination as claimed in claim 1, comprising from 50 to 72.9% by weight of component A, from 25 to 50% by weight of component B, from 2 to 10% by weight of component C, from 0.1 to 2% by weight of component D, and from 0 to 1% by weight of component E.

5. The flame retardant-stabilizer combination as claimed in claim 1, wherein component B is a condensate of melamine compounds of higher condensation levels or a mixture thereof.

6. The flame retardant-stabilizer combination as claimed in claim 1, wherein component B is a reaction product of melamine with polyphosphoric acid, a reaction product of condensates of melamine with polyphosphoric acid or mixtures thereof.

7. The flame retardant-stabilizer combination as claimed in claim 1, wherein component B is dimelamine pyrophosphate, melamine polyphosphate, melem polyphosphate, melam polyphosphate, melon polyphosphate, mixed polysalts thereof and mixtures thereof.

8. The flame retardant-stabilizer combination as claimed in claim 1, wherein the phosphorus/nitrogen flame retardant is a nitrogen-containing phosphate of the formulae (NH₄)_{y}H_{3-y} PO₄ or (NH₄PO₃)_{z}, wherein y is from 1 to 3 and z is from 1 to 10 000.

9. The flame retardant-stabilizer combination as claimed in claim 8, wherein the nitrogen-containing synergist is of the formulae (II) to (VII) or mixtures thereof 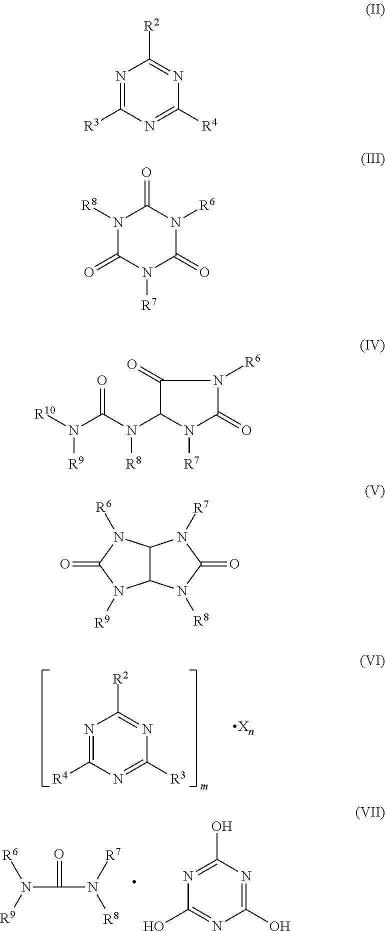
wherein
R² to R⁴ are hydrogen, C₁-C₈-alkyl or C₅-C₁₆-cycloalkyl or -alkylcycloalkyl, optionally substituted with a hydroxy or C₁-C₄-hydroxyalkyl function, C₂-C₈-alkenyl, C₁-C₈-alkoxy, -acyl, or -acyloxy, C₆-C₁₂-aryl or -arylalkyl, —OR⁵, —N(R⁵)R⁶, including systems of alicyclic-N or aromatic-N type,
R⁵ is hydrogen, C₁-C₈-alkyl or C₅-C₁₆-cycloalkyl or -alkylcycloalkyl, optionally substituted with a hydroxy or C₁-C₄-hydroxyalkyl function, C₂-C₈-alkenyl, C₁-C₈-alkoxy, -acyl, or -acyloxy, or C₆-C₁₂-aryl or -arylalkyl,
R⁶ to R¹⁰ are the same groups as R⁵ or are —O—R⁵,
m and n are independently 1, 2, 3, or 4,
X is an acid that form adducts with triazine compounds (II);
or an oligomeric ester of tris(hydroxyethyl) isocyanurate with aromatic polycarboxylic acids.

10. The flame retardant-stabilizer combination as claimed in claim 1, wherein the nitrogen-containing synergist is benzoguanamine, tris(hydroxyethyl) isocyanurate, allantoin, glycoluril, melamine, melamine cyanurate, dicyandiamide, guanidine or a mixture thereof.

11. The flame retardant-stabilizer combination as claimed in claim 1, wherein the phosphite and phosphonite are triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, bisisodecyloxy pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocin, 6-fluoro-2,4,8,10-tetra-tert-butyl-12-methyldibenzo[d,g]-1,3,2-dioxaphosphocin, bis(2,4-di-tert-butyl-6-methylphenyl) methyl phosphite bis(2,4-di-tert-butyl-6-methylphenyl) ethyl phosphite or a mixture thereof.

12. The flame retardant-stabilizer combination as claimed in claim 1, wherein component E is a reaction product of long-chain fatty acids having from 14 to 40 carbon atoms with polyhydric alcohols alkali metal, alkaline earth metal, aluminum, zinc salts of long-chain fatty acids having from 14 to 40 carbon atoms or a mixture thereof.

13. A flame-retardant plastics molding composition comprising a flame retardant-stabilizer combination including as component A from 50 to 95% by weight of a monoarylphosphinic salt of the general formula (I) 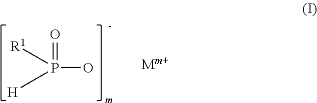
wherein
R¹ is an unsubstituted or substituted C₆-C₁₅-aryl group, a C₇-C₁₆-alkylaryl group or a C₇-C₁₆-arylalkyl group;
M is Mg, Ca, Al, Sb, Sn, Ge, Ti, Zn, Fe, Zr, Ce, Bi, Sr, Mn, Li, Na, K, a protonated nitrogen base or a mixture thereof;
as component B from 5 to 50% by weight of a nitrogen-containing synergist, of a phosphorus/nitrogen flame retardant or a mixture thereof; as component C from 0 to 10% by weight of magnesium oxide, calcium oxide, zinc oxide, manganese oxide, tin oxide, aluminum hydroxide, boehmite, magnesium hydroxide, hydrotalcite, hydrocalumite, calcium hydroxide, zinc hydroxide, tin oxide hydrate, manganese hydroxide, zinc borate, zinc hydroxystannate, zinc stannate or a mixture thereof; as component D from 0 to 3% by weight of a mixture of a phosphonite or of a phosphonite/phosphite mixture, and as component E from 0 to 3% by weight of an ester or salt of long-chain aliphatic carboxylic acids having from 14 to 40 carbon atoms, where the entirety of the components A to E totals 100% by weight, wherein the plastic is HI (high-impact) polystyrene, polyphenylene ether, polyamides, polyesters, polycarbonates, or blends or polymer blends of the type represented by ABS (acrylonitrile-butadiene-styrene) PC/ABS (polycarbonate/acrylonitrile-butadiene-styrene), or PPE/HIPS (polyphenylene ether/HI polystyrene) plastics.

14. The flame-retardant plastics molding composition as claimed in claim 13, comprising
from 50 to 98% by weight of the plastic,
from 2 to 50% by weight of the flame retardant-stabilizer combination, and
from 0 to 50% by weight of additives.

15. A polymer molding, polymer film, polymer filament, or polymer fiber comprising a flame retardant-stabilizer combination including as component A from 50 to 95% by weight of a monoarylphosphinic salt of the general formula (I) 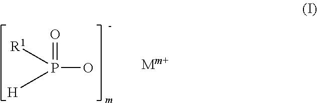
wherein
R¹ is an unsubstituted or substituted C₆-C₁₅-aryl group, a C₇-C₁₆-alkylaryl group or a C₇-C₁₆-arylalkyl group;
M is Mg, Ca, Al, Sb, Sn, Ge, Ti, Zn, Fe, Zr, Ce, Bi, Sr, Mn, Li, Na, K, a protonated nitrogen base or a mixture thereof;
as component B from 5 to 50% by weight of a nitrogen-containing synergist, of a phosphorus/nitrogen flame retardant or a mixture thereof; as component C from 0 to 10% by weight of magnesium oxide, calcium oxide, zinc oxide, manganese oxide, tin oxide, aluminum hydroxide, boehmite, magnesium hydroxide, hydrotalcite, hydrocalumite, calcium hydroxide, zinc hydroxide, tin oxide hydrate, manganese hydroxide, zinc borate, zinc hydroxystannate, zinc stannate or a mixture thereof; as component D from 0 to 3% by weight of a mixture of a phosphonite or of a phosphonite/phosphite mixture, and as component E from 0 to 3% by weight of an ester or salt of long-chain aliphatic carboxylic acids having from 14 to 40 carbon atoms, where the entirety of the components A to E totals 100% by weight, wherein the polymer is HI (high-impact) polystyrene, polyphenylene ethers, polyamides, polyesters, polycarbonates, or blends or polymer blends of ABS (acrylonitrile-butadiene-styrene) or PC/ABS (polycarbonate/acrylonitrile-butadiene-styrene), polyamide, polyester, ABS or a mixture thereof.

16. The polymer molding, polymer film, polymer filament, or polymer fiber as claimed in claim 15, comprising
from 50 to 98% by weight of the polymer,
from 2 to 50% by weight of the flame retardant-stabilizer combination,
from 0 to 50% by weight of additives.

17. The flame retardant-stabilizer combination as claimed in claim 1, wherein R¹ is 2,4,6-trimethylphenyl.

18. The flame retardant-stabilizer combination as claimed in one or more of claim 1, wherein component B is a melem, melam, melon or a mixture thereof.

19. The flame retardant-stabilizer combination as claimed in claim 1, wherein component E is ethylene glycol, glycerol, trimethylolpropane, pentaerythritol or a mixture thereof.
